(19) United States
(12) Patent Application Publication
(10) Pub. No.: US 2025/0156706 A1
(43) Pub. Date: May 15, 2025

(54) PSEUDO RANDOM PROJECTION FOR MACHINE LEARNING COMPRESSION

(71) Applicant: Apple Inc., Cupertino, CA (US)

(72) Inventors: Saman NADERIPARIZI, Seattle, WA (US); David HARRISON, Seattle, WA (US); Mahyar NAJIBIKOHNEHSHAHRI, Santa Clara, CA (US); Mohammad RASTEGARI, Kirkland, WA (US); Rasoul SHAFIPOUR, Bellevue, WA (US)

(21) Appl. No.: 18/824,898

(22) Filed: Sep. 4, 2024

Related U.S. Application Data
(60) Provisional application No. 63/548,223, filed on Nov. 13, 2023.

(51) Int. Cl. G06N 3/08

(52) U.S. Cl. CPC G06N 3/08

(57) ABSTRACT

The subject technology provides for pseudo random projection for machine learning compression. An apparatus determines a first data structure comprising pseudo random values and a second data structure comprising one or more learned values based on a target compression ratio of a first dimension associated with a first weight matrix to a second dimension. The apparatus generates the second weight matrix comprising the second data structure and a seed value associated with the first data structure. The second weight matrix may be generated based at least in part on the pseudo random values and the one or more learned values. The second weight matrix is a compressed version of the first weight matrix based on the target compression ratio. The apparatus also trains a neural network with the second weight matrix to produce a trained machine learning model.

### CROSS-REFERENCE TO RELATED APPLICATION(S)

This application claims the benefit of U.S. Provisional Application Ser. No. 63/548,223, entitled “PSEUDO RANDOM PROJECTION FOR MACHINE LEARNING COMPRESSION,” and filed on Nov. 13, 2023, the disclosure of which is expressly incorporated by reference herein in its entirety.

### TECHNICAL FIELD

The present description generally relates to pseudo random projection for machine learning compression.

### BACKGROUND

Large language models are characterized by their substantial size, often comprising hundreds of millions to billions of parameters. These models require significant computational power and memory for training and inference. The vast number of parameters allows them to capture complex linguistic patterns and generate coherent and contextually relevant text, making them powerful tools in natural language processing tasks. However, their size also presents challenges related to resource consumption and deployment on constrained platforms.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example computing architecture for pseudo random projection co-design approach for machine learning compression in accordance with one or more implementations.

FIG. 3 conceptually illustrates an example overview of a pseudo random projection system for machine learning compression in accordance with one or more implementations.

FIG. 4 conceptually illustrates another example overview of a pseudo random projection system for machine learning compression in accordance with one or more implementations.

FIG. 5 illustrates an inference engine pipeline of a pseudo random projection system for machine learning compression in accordance with one or more implementations.

FIG. 6 illustrates a schematic diagram of an example linear feedback shift register (LFSR) in accordance with one or more implementations.

FIG. 7 illustrates a schematic diagram of an example seed-based projection in accordance with one or more implementations.

FIG. 8 is a flow chart of an example process that may be performed for pseudo random projection for machine learning compression in accordance with one or more implementations.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of training data, and advances in more powerful and efficient computing hardware. Machine learning may utilize models that are executed to provide predictions in particular applications.

Large language models (LLMs) have shown an increase in performance on complex language tasks. As a result, there is a growing interest in deploying these models on-device to ensure user privacy. However, even the smallest state-of-the-art LLMs are too large for on-device execution.

Due to the high-quality performance demonstrated by LLMs in various complex language tasks, there is significant interest in deploying these LLMs on mobile devices for faster responses and improved privacy protection. However, the substantial size of LLMs, with billions of parameters, necessitates highly effective compression techniques to accommodate storage-limited devices.

The subject technology provides for the utilization of pseudo randomly generated matrices for on-the-fly computation of neural network weights. In one or more implementations, this computation may refer to a process of dynamically calculating or adjusting the weights of a neural network in real-time during a training phase or an inference task. In one or more other implementations, the primary objective is to diminish the memory footprint of the neural network weights, specifically for LLM models.

The subject technology also provides for a hardware-machine learning (HW-ML) co-design approach for the construction of an artificial intelligence (AI) accelerator, incorporating the utilization of pseudo random projection (PRP). This co-design approach aims to synergize hardware architecture with machine learning principles to optimize the performance of an AI accelerator. In one or more implementations, an AI accelerator may be a specialized hardware component configured to perform complex computations for ML tasks more efficiently than general-purpose processors. An AI accelerator may optimize and speed up processes such as neural network training and inference by handling large-scale parallel computations, reducing power consumption, and improving overall performance. The incorporation of pseudo random projection introduces a novel dimension to the design of the AI accelerator, leveraging randomized techniques to enhance computational efficiency. PRP can serve as a mechanism to project high-dimensional data onto lower-dimensional spaces, mitigating computational complexities associated with traditional approaches. The co-design approach facilitates the symbiotic relationship between hardware architecture and machine learning algorithms, exploiting PRP to achieve accelerated processing while maintaining precision in AI computations.

Embodiments of the subject technology provide for a pseudo random projection technique for machine learning compression. An apparatus determines a first data structure comprising pseudo random values and a second data structure comprising one or more learned values based on a target compression ratio of a first dimension associated with a first weight matrix to a second dimension. The apparatus generates a second weight matrix that includes the second dimension with the second data structure and a seed value associated with the first data structure. In one or more implementations, the second weight matrix is generated based at least in part on the pseudo random values and the one or more learned values. In one or more implementations, the second weight matrix is a compressed version of the first weight matrix based on the target compression ratio. In one or more implementations, the apparatus can produce a trained machine learning model by training a neural network with the second weight matrix.

In one or more implementations, one of the advantages of using a compressed weight matrix such as the second weight matrix is the significant reduction in memory requirements. This memory footprint reduction allows for the deployment of machine learning models on resource-constrained devices such as mobile phones and embedded systems. Additionally, machine learning models with compressed weight matrices may exhibit faster inference times due to reduced computational overhead. This can result in more efficient processing and lower energy consumption, which are particularly beneficial in real-time applications. Furthermore, machine learning models with compressed weight matrices can be transmitted more quickly over networks due to their smaller size, facilitating easier updates and distribution. The use of a compressed weight matrix in machine learning model generation therefore can enhance the machine learning model's efficiency and scalability without substantially compromising performance.

Implementations of the subject technology also improve the ability of a given electronic device to provide machine-learning generated data to a user (e.g., a user of the given electronic device). These benefits therefore are understood as improving the computing functionality of a given electronic device, such as an end user device which may generally have less computational and/or power resources available than, e.g., one or more cloud-based servers.

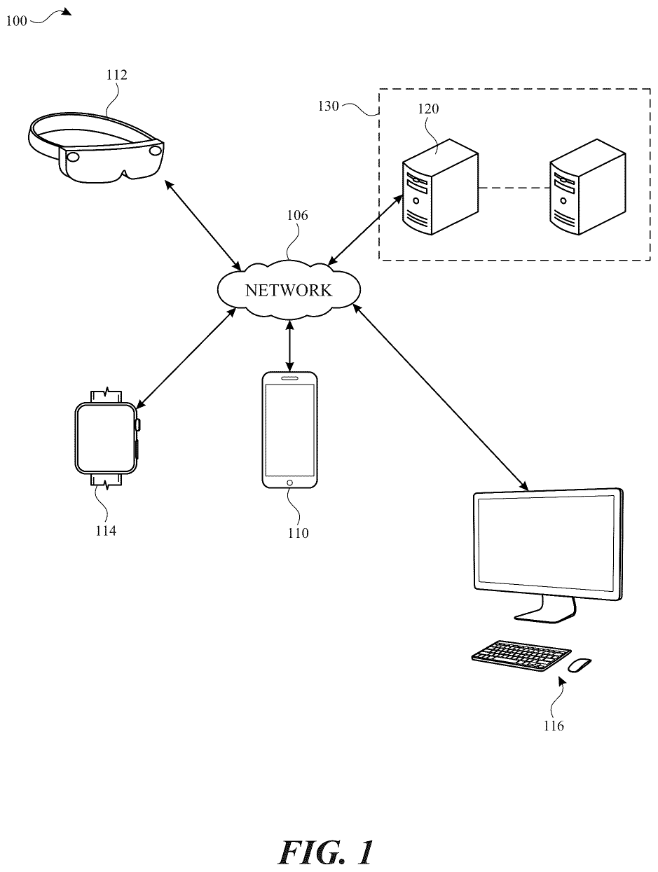

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, and the server 120; however, the network environment 100 may include any number of electronic devices and any number of servers or a data center including multiple servers.

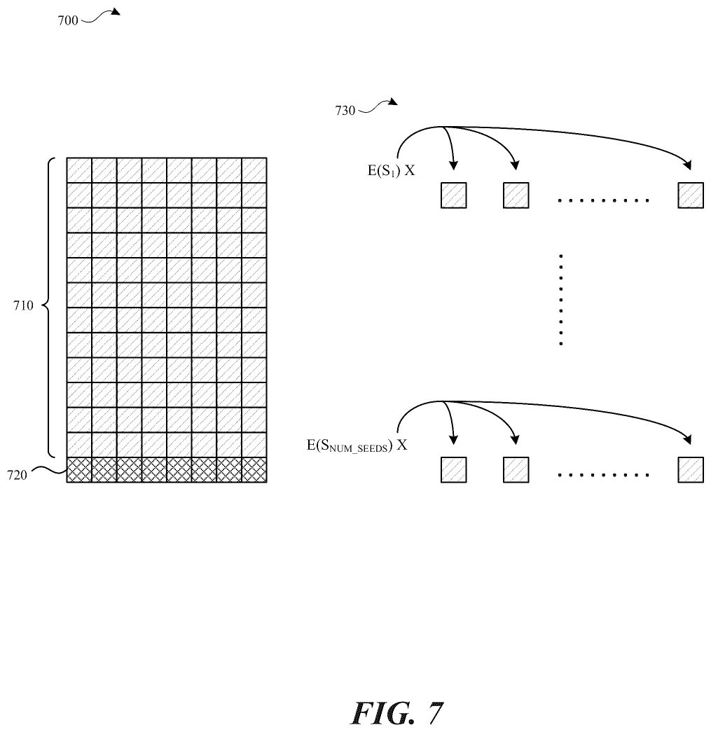

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 7.

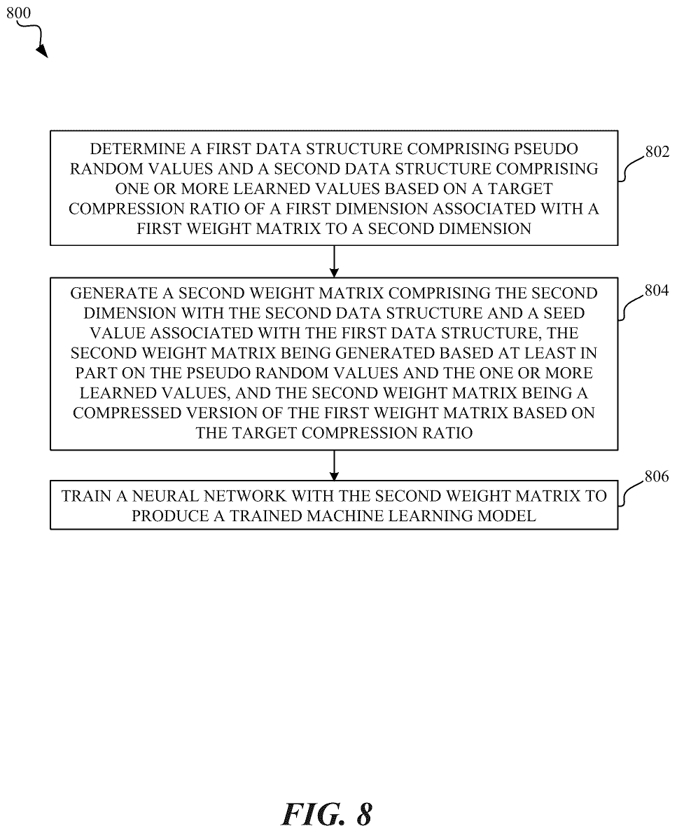

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 8.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 8.

In one or more implementations, one or more of the electronic devices 110-116 may provide a system for training a machine learning model using training data, where the trained machine learning model is subsequently deployed to one or more of the electronic devices 110-116. Further, one or more of the electronic devices 110-116 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-116 may be performed entirely on the electronic devices 110-116, to prevent exposure of individually identifiable data to devices and/or systems that are not authorized by the user.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

The server 120 may provide a system for training a machine learning model using training data, where the trained machine learning model is subsequently deployed to the server 120 and/or to one or more of the electronic devices 110-116. In an implementation, the server 120 may train a given machine learning model for deployment to a client electronic device (e.g., the electronic device 110, the electronic device 112, the electronic device 114, the electronic device 116). In one or more implementations, the server 120 may train portions of the machine learning model that are trained using (e.g., anonymized) training data from a population of users, and one or more of the electronic devices 110-116 may train portions of the machine learning model that are trained using individual training data from the user of the electronic devices 110-116. The machine learning model deployed on the server 120 and/or one or more of the electronic devices 110-116 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

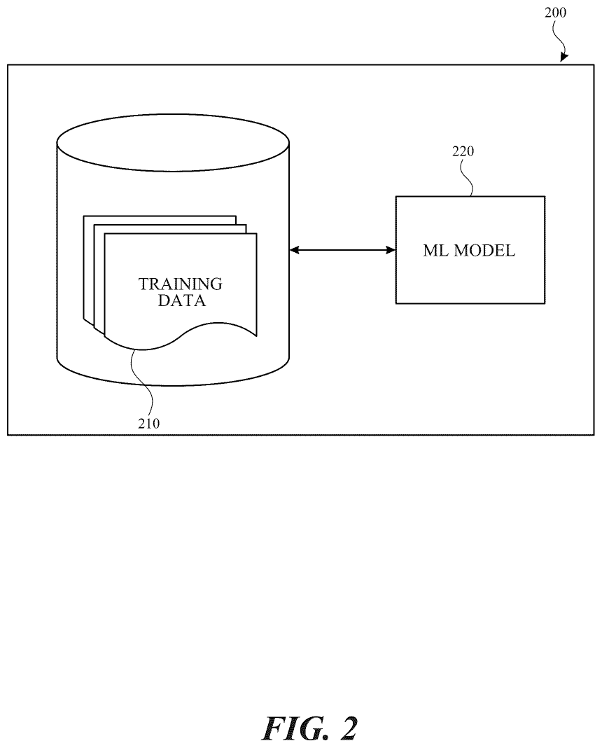

FIG. 2 illustrates an example computing architecture for a system providing machine learning models, in accordance with one or more implementations. For explanatory purposes, the computing architecture is described as being provided by an electronic device 200, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the electronic device 200 includes training data 210 for training a machine learning model. In an example, the server 120 may utilize one or more machine learning algorithms that uses training data 210 for training a machine learning (ML) model 220. Machine learning model 220 may include one or more neural networks.

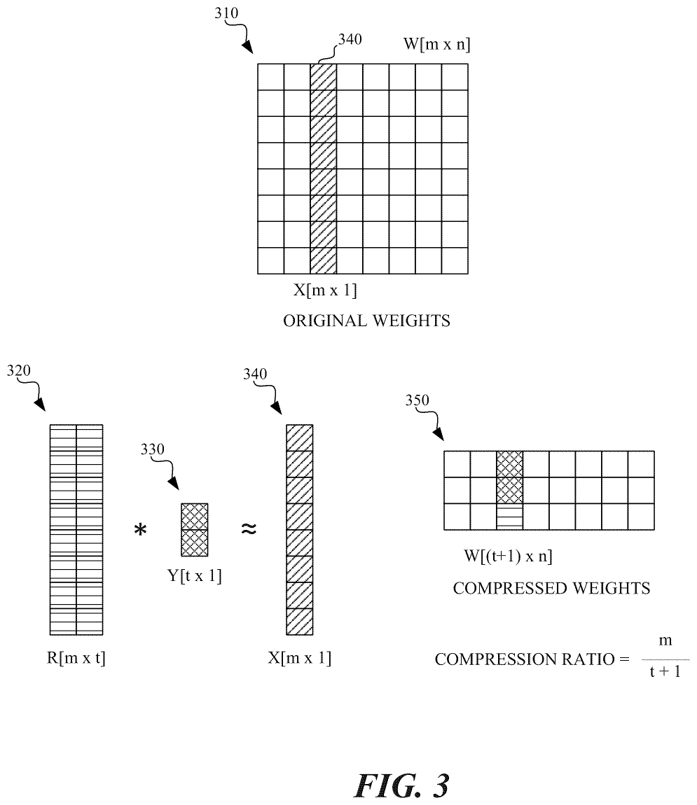

FIG. 3 conceptually illustrates an example overview of a pseudo random projection system for machine learning compression in accordance with one or more implementations. As illustrated in FIG. 3, a first weight matrix 310 includes original weights utilized in training a machine learning model, such as the ML model 220 of FIG. 2. The first weight matrix 310 is a two-dimensional array defined as W[m×n], where m represents the number of rows and n represents the number of columns. In one or more implementations, the first weight matrix 310 includes a vector X 340 defined as X[m×1]. In one or more implementations, the vector X 340 represents a single column (e.g., “m”) of the first weight matrix 310. In one or more other implementations, the vector X 340 represents multiple columns of the first weight matrix 310. In one or more other implementations, the vector X 340 represents a portion of one column or across multiple columns of the first weight matrix 310.

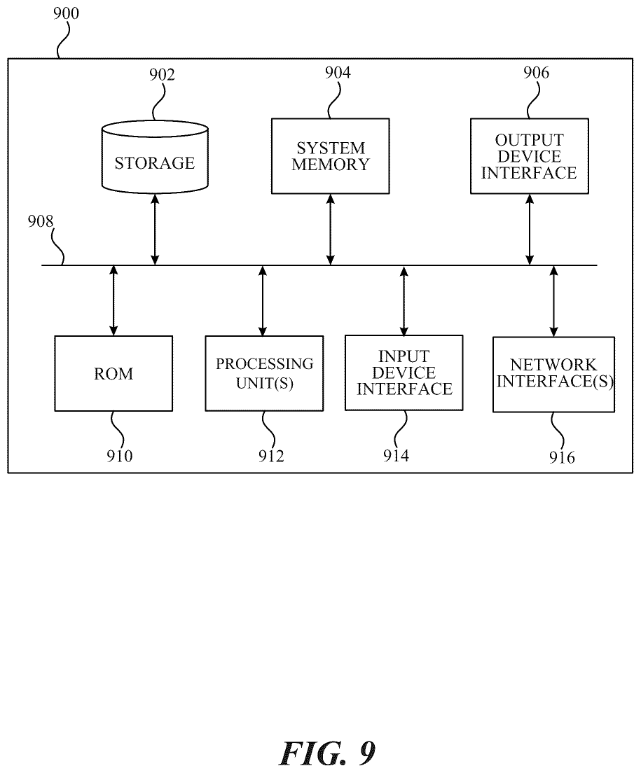

In one or more implementations, preservation of the vector X 340 is supplanted by storage of a seed value for tensor R 320 defined as R[m×t] and a modestly sized learned vector Y 330 defined as Y[t×1] in memory (e.g., permanent storage device 902 of FIG. 9), thereby facilitating the objective to diminish the memory footprint of the neural network weights. The execution of the multiplication operation between the tensor R 320 and the vector Y 330 may take place during an inference task, facilitating the computation of an approximation for the vector X 340.

The acquisition of the vector Y 330 may transpire through a training phase of the ML model 220, involving a predefined collection of tensor R 320 matrices. Throughout the training phase, iterative procedures traverse diverse sets of tensor R 320 to discern an optimal pairing between a seed value associated with the tensor R 320 and the vector Y 330 (e.g., R< >Y pairs) that yields the highest accuracy concerning a target compression ratio of a first dimension, m, associated with the first weight matrix 310 to a second dimension, t+1, (e.g., m/t+1). In one or more implementations, each seed value can generate a specific pseudo-random matrix (e.g., the tensor R 320). This matrix can then be used to determine a corresponding learned vector (e.g., vector Y 330). The process may involve varying the seed value, resulting in different learned vectors. The optimal pair can be identified by selecting the best combination of seed and learned vector based on predefined criteria. This approach facilitates the refinement of the relationship between the tensor R 320 and the vector Y 330, enhancing the efficiency and precision of neural network computations in achieving desired weight compression goals. As illustrated in FIG. 3, a second weight matrix 350 can be generated with one or more compressed weight vectors. For example, the second weight matrix 330 may be generated based at least in part on the seed value associated with the pseudo random values of the tensor R 320 and the one or more learned values of the vector Y 330. In this regard, the second weight matrix 350 is a compressed version of the first weight matrix 310 based on the target compression ratio. In one or more implementations, the second weight matrix 350 includes a compressed weight vector defined as W[(t+s)×n], which includes the vector Y 330 and a seed value(s) associated with the tensor R 320. In one or more implementations, the target compression ratio assumes that the bit precision of the weight values in the second weight matrix 350 are the same as the bit precision of the seed value and the bit precision of the values in the vector Y 330. For example, if the weights of the first weight matrix are represented using 16-bit precision, the seed value is represented using 32-bit precision, and the values in the vector Y 330 are represented using 4-bit precision, with a chunk size (m) of 32 and the length of the vector Y 330 (t) set to 32, then the compression ratio can be calculated as follows: (16*32)/(4*32+32)=3.2. In another example, with t set to 64, the compression ratio can be calculated as follows: (16*32)/(4*64+32)=1.78, which is still greater than 1. The aim is to reduce the overall model size by achieving a compression ratio greater than 1.

The acquisition of the vector Y 330 encompasses several methodologies within the training framework of the ML model 220. In one or more implementations, the acquisition of the vector Y 330 encompasses a direct acquisition of the vector Y 330 by accumulating gradients through the equation X[m×1]=R[m×t]*Y[t×1], thereby parameterizing the ML model 220 with vector Y 330. In one or more other implementations, the acquisition of the vector Y 330 is performed by learning the entirety of the first weight matrix 310. Subsequently, an optimal vector Y 330 matrix is determined, given the tensor R 320, to reconstruct the vector X 340 utilizing linear least squares fitting techniques, or alternative local or end-to-end loss functions.

In one or more implementations, the electronic device 200 of FIG. 2 can reset the vector X 340 to the approximation at regular intervals, such as every 10 steps. In one or more other implementations, the approximation of the vector X 340 can be exclusively employed during the forward pass of the neural network in the ML model 220, with the gradient accumulating the complete first weight matrix 310 during a subsequent backward pass of the neural network. This utilization of approximation methods and parameter adjustments contributes to the optimization of the ML model 220 performance and the iterative refinement of the vector Y 330, enhancing the accuracy and efficiency of the overall computational process.

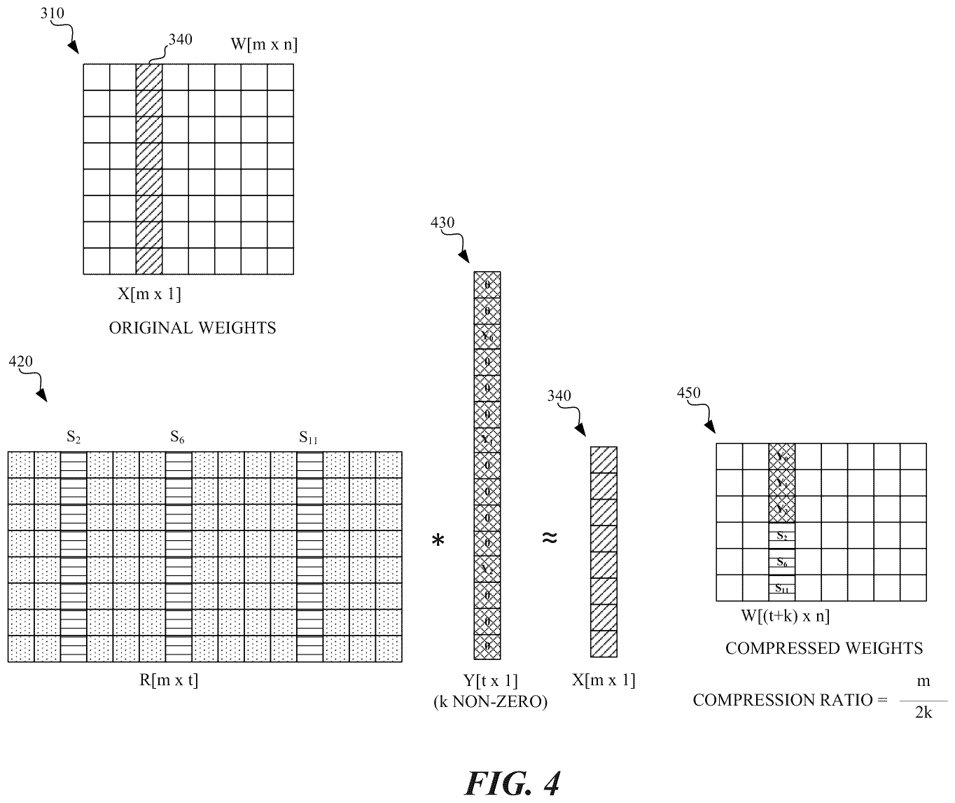

FIG. 4 conceptually illustrates another example overview of a pseudo random projection system for machine learning compression in accordance with one or more implementations. In contrast to the iteration of sets of tensor R 320 as described with reference to FIG. 3, the subject technology provides for the selection, for each Y value of vector Y 430 defined as Y[t×1] with k non-zero values, of a sparse combination from a significantly larger set of R vectors within tensor R 420 defined as R[m×t], where t denotes the size of this enlarged set. This technique results in an expanded parameter space compared to the parameter space described with reference to FIG. 3, providing the flexibility to maintain compression with small, sparse Y values. In one or more implementations, only indices and values at non-zero locations of the vector Y 430 are stored in memory (e.g., the permanent storage device 902). In one or more implementations, the tensor R 420 includes vectors of pseudo random values at sparse locations within the tensor R 420 (e.g., S₂, S₆, S₁₁).

In one or more implementations, this methodology can be implemented during the training phase of the ML model 220 through various approaches. In one or more implementations, one approach involves utilizing orthogonal matching pursuit (OMP) and other sparse linear techniques. In one or more implementations, the subject technology provides for solving for a sparse vector Y 430 given a substantial tensor R 420 and a target full weight matrix (e.g., 340) for approximation. In one or more implementations, the one or more learned values of the vector Y 430 includes zero values and non-zero values (e.g., Y₀, Y₁, Y₂) at sparse locations within the vector Y 430. In one or more implementations, the non-zero values of the vector Y 430 correspond to respective vectors of pseudo random values in the tensor R 420. This approximation of the vector X 340 can be executed at defined intervals, such as every 10 iterations of training the ML model 220, in which gradients can be accumulated towards a complete weight matrix during that period. As illustrated in FIG. 4, a second weight matrix 450 can be generated with one or more compressed weight vectors. In this regard, the second weight matrix 450 is a compressed version of the first weight matrix 310 based on a target compression ratio of a first dimension, m, associated with the first weight matrix 310 to a second dimension,

$$2 k ( e . g . , \frac{m}{2 k} ) .$$

In one or more implementations, the second weight matrix 450 includes a compressed weight vector defined as W[(t+k)×n], which includes the non-zero values (e.g., Y₀, Y₁, Y₂) of the vector Y 430 and a seed vector associated with the tensor R 420. In one or more implementations, the seed vector includes the seed values (e.g., S₂, S₆, S₁₁) associated with the vectors of pseudo random values in the tensor R 420.

In one or more other implementations, the Y values of the vector Y 430 can be determined by a direct learning approach, bypassing the intermediate step of learning and approximating the entire first weight matrix 310. In this regard, the equation R[m×t]*Y[t×1] may be directly connected to the graph, serving as a substitute for the full weight matrix (e.g., vector X 340). In one or more implementations, a sparsity-seeking penalty, such as L1 loss, may be imposed on the vector Y 430 to enforce desired characteristics. This integration of sparse linear techniques and direct learning mechanisms contributes to the adaptability and optimization of the ML model 220 during the training phase.

In one or more implementations, the scalability of the ML model 220 may be contingent upon the dimensions of the basis/dictionary of the tensor R 420. However, in one or more implementations, this scalability introduces concurrent computational expenses and substantial memory overhead, particularly in instances where the tensor R 420 is fully instantiated in cache/memory (e.g., 802) before undergoing multiplication with the vector Y 430. This stands in contrast to more intricate methodologies that adopt a streaming approach, materializing the tensor R 420 incrementally, albeit with increased implementation complexity.

To address both computational and memory challenges, embodiments of the subject technology provide for constraining the tensor R 420 as a circulant matrix. In one or more other implementations, the tensor R 420 may be employed as a circulant matrix in scenarios where the parameter “t” attains significant magnitudes, exceeding several hundred. A circulant matrix is one where its rows and columns represent rotations of each other, and elements transition in and out of view in instances where the matrix is non-square. In one or more implementations, such constraints present a departure from resource-intensive practices, particularly those entailing the complete instantiation of the tensor R 420. In one or more implementations, circulant matrices, formed by rotating a single pseudo random vector (of length max(m, t)), demonstrate comparable performance to a fully random tensor R (e.g., tensor R 420). This equivalence arises from the uncorrelated nature of rows and columns in expectation, ensuring an efficient and optimized neural network operation.

When the tensor R 420 is circulant, the multiplication operation involving the tensor R 420 and the vector Y 430 can be reformulated in convolution terms, incorporating circulant padding for the tensor R 420. This convolution operation between the tensor R 420 and the vector Y 430 may benefit from its widespread and efficient implementation as a primitive on numerous AI accelerators. Consequently, a readily available implementation for R[m×t]*Y[t×1] is achieved, obviating the necessity to materialize the tensor R 420 matrix. Instead, a single circulant vector of length max(m, t) can be utilized. This approach can effectively minimize the memory footprint of neural network weights without necessitating the aforementioned implementations for the R*Y operation.

In one or more implementations, explicit convolutions entail a computational complexity of O(a*b), where a and b represent the lengths of the two vectors undergoing convolution. In one or more implementations, a is defined as max(m, t), with m being a constant. Assuming the scenario involves a substantial value for t (t>m), the computational complexity reduces to O(tm).

In one or more other implementations, computation of a convolution involves an element-wise product of two vectors in the Fourier space, each of length max(m, t). Leveraging the efficiency of the Fast Fourier Transform (FFT), this convolution computation can be executed with a time complexity of O(t*log(t)), assuming t>m. In one or more implementations, this approach proves significantly faster, particularly in cases where both t and m assume large values, compared to the O(t*m) complexity associated with explicit convolutions. By utilizing the efficiency of FFT, the computational complexity is markedly reduced, yielding a faster computational process. In one or more implementations, this departure from explicit convolutions enhances the overall efficiency of the convolution operation, especially when confronted with scenarios characterized by large values of t and m.

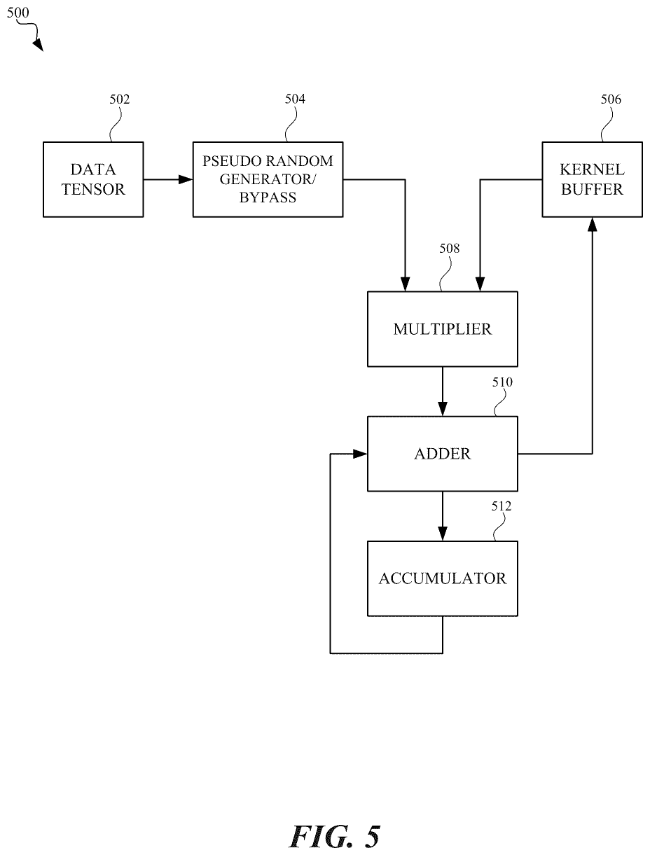

FIG. 5 illustrates an inference engine pipeline 500 of a pseudo random projection system for machine learning compression in accordance with one or more implementations. As illustrated in FIG. 5, the inference engine pipeline 500 includes an architecture of a multiply-accumulate (MAC) unit for training machine learning models. The inference engine pipeline 500 includes a data tensor 502, a pseudo random generator 504, a kernel buffer 506, a multiplier 508, an adder 510 and an accumulator 512.

The data tensor 502, representing the input data, serves as a fundamental element in the inference engine pipeline 500. The data tensor 502 may contain values of features or activations for initiating a convolutional operation performed by the multiplier 508. The kernel buffer 506, storing weights and/or kernels for the convolutional operation, complements the data tensor 502. Both the data tensor 502 and the kernel buffer 506 can contribute to shaping the convolutional operations within the MAC unit.

In one or more implementations, the inference engine pipeline 500 may include input registers that act as interface points between the data tensor 502 and the kernel buffer 506, and the computational components within the MAC unit. These input registers can store the input values before they undergo multiplication in the subsequent stages, such as the multiplier 508.

The multiplier 508 is a computational engine within the MAC unit. The multiplier 508 can receive input values from the data tensor 502 and the kernel buffer 506 via the input registers and executes one or more multiplication operations. The intermediate products generated by the multiplier 508 are then directed to the adder 510 and subsequently to the accumulator 512.

The adder 510 functions as a summation unit, continuously summing the results of the multiplication operation. The adder 510 can maintain a dynamic connection with the multiplier 508, receiving products in each cycle and updating a weighted sum.

The accumulator 512 functions as a storage unit, continuously accumulating the weighted sums from the adder 510. The accumulator 512 can maintain a dynamic connection with the adder 510, receiving weighted sums in each cycle and updating the cumulative sum over successive iterations. This iterative process forms the backbone of the multiply-accumulate operation for training machine learning models.

The data flow begins with the data tensor 502 and the pseudo random generator 504. The pseudo random generator 504 and the kernel buffer 506 respectively supply pseudo random values and small learned vector values to the multiplier 508, which are then processed by the multiplier 508, generating intermediate products that are subsequently summed by the adder 510. The weighted sums produced by the adder 510 are subsequently accumulated by the accumulator 512.

In contemporary inference engines, whether implemented with central processing unit (CPU) or hardware accelerators, the generation of a substantial number of R tensors on-the-fly may entail a notable latency unless dedicated pseudo random generator hardware (e.g., the pseudo random generator 504) is employed. In one or more implementations, the inference engine pipeline 500 enables the generation of R tensors in real-time concurrent with the execution of an inference task. In one or more implementations, the pseudo random generator 504 includes one or more linear feedback shift registers (LFSR) modules due to their cost-effectiveness in terms of both area and power. By integrating dedicated pseudo random generator hardware, such as the pseudo random generator 504, into the MAC units, the inference engine pipeline 500 can efficiently overcome the latency challenges associated with on-the-fly generation of R tensors.

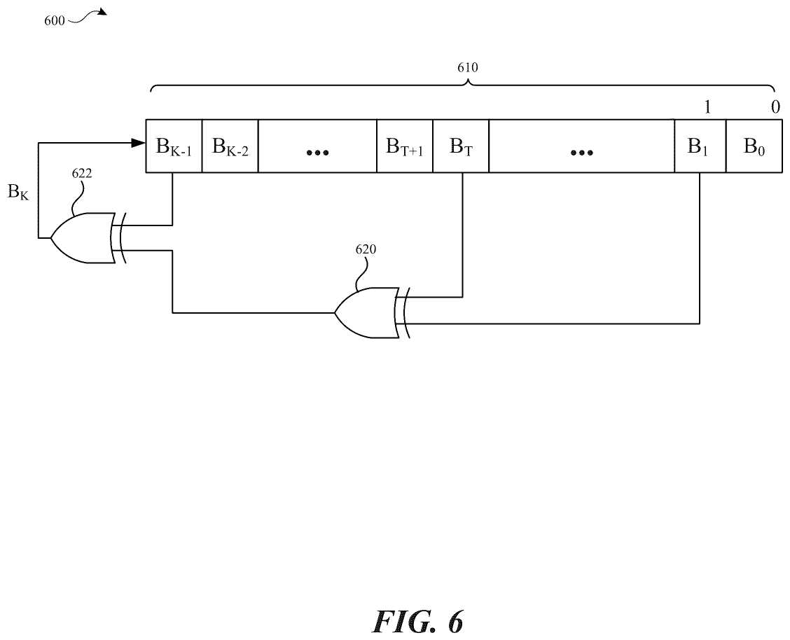

FIG. 6 illustrates a schematic diagram of an example LFSR 600 in accordance with one or more implementations. In one or more implementations, the close form formulation for the LFSR 600 is utilized to explore methods for making the LFSR 600 differentiable, or partially differentiable, with respect to the seed value. This approach permits the adjustment of seed values during training. This parameter, if systematically learned-such as by updating based on gradient values—has the potential to enhance the flexibility of the ML model 220. Consequently, this can improve the end-to-end performance of the pseudo random projection method, as described with reference to the pseudo random generator 504 of FIG. 5. The systematic learning of the seed values enables the adaptation of the ML model 220 to optimize its performance based on the gradients derived during the training process.

In one or more implementations, the LFSR 600 includes a k-bit shift register 610 and a feedback polynomial x^{k}+x^{t+1}+x²+1. The values within the registers of the k-bit shift register 610 may represent the seed value, which is the initial state of the LFSR 600. The seed value for the LFSR 600 shown is represented in binary as bₖ₋₁bₖ₋₂ . . . b₁b₀. In one or more implementations, the XOR operation (e.g., XOR 620, 622) on single bits is equivalent to addition modulo 2, which is addition over the Galois Field GF(2), effectively ignoring the carry bit from the adder 510 of FIG. 5. The formulation for bₖ based on bₖ₋₁bₖ₋₂ . . . b₁b₀ can be expressed as follows:

$${b}_{k} = ( {\sum }_{i = 0}^{k - 1} {a}_{i} {b}_{i} ) \%2 , where {a}_{i} {b}_{i} ∈ \{ 0 , 1 \} . \qquad Eq . ( 1 )$$

In one or more implementations, (aₖ₋₁aₖ₋₂ . . . aⱼa₀) specifies which bits are included in the XOR operations (e.g., XOR 620, 622), which can be referred to as “taps.” Specifically, aᵢ is “1” if bᵢ is included in the XOR operations; otherwise, aᵢ is “0.” The state of the LFSR 600, denoted as bₖ₋₁bₖ₋₂ . . . b₁b₀, after the first clock cycle, can be derived and represented in matrix format as follows:

$$[ \begin{matrix}{b}_{1} \\ {b}_{2} \\ ⋮ \\ {b}_{k}\end{matrix} ] = T [ \begin{matrix}{b}_{0} \\ {b}_{1} \\ ⋮ \\ {b}_{k - 1}\end{matrix} ] , where T = [ \begin{matrix}0 & 1 & 0 & … & 0 \\ 0 & 0 & 1 & & 0 \\ ⋮ & ⋮ & ⋮ & … & ⋮ \\ {a}_{0} & {a}_{1} & {a}_{2} & … & {a}_{k - 1}\end{matrix} ] . \qquad Eq . ( 2 )$$

This matrix format allows for a systematic computation of the subsequent state based on the initial seed and the feedback polynomial. In one or more implementations, any arbitrary state of the LFSR 600 after n clock cycles, denoted as bₖ₊ₙ₋₁bₖ₊ₙ₋₂ . . . bₙ₊₁bₙ, can be represented as follows:

$$[ \begin{matrix}{b}_{n} \\ {b}_{n + 1} \\ ⋮ \\ {b}_{k + n - 1}\end{matrix} ] = {T}^{n} [ \begin{matrix}{b}_{0} \\ {b}_{1} \\ ⋮ \\ {b}_{k - 1}\end{matrix} ] . \qquad Eq . ( 3 )$$

This representation facilitates the calculation of the state of the LFSR 600 after a specified number of clock cycles, accounting for the initial seed and the feedback polynomial applied through the XOR operations. The matrix format facilitates a precise and systematic computation of the state of the LFSR 600 at any given time step. In one or more implementations, the relationship between all outputs and the initial seed b₀ . . . bₖ₋₁ is linear over GF(2). Neural networks may optimize linear relationships effectively. In one or more implementations, the modulo 2 operation may introduce non-differentiability to the output. In one or more other implementations, an initial seed can be learned using gradient descent, enhancing the overall system's efficiency and accuracy.

FIG. 7 illustrates a schematic diagram of an example seed-based projection 700 in accordance with one or more implementations. In one or more implementations, a generator (e.g., the pseudo random generator 504 of FIG. 5) may populate a matrix from a limited number of initial states. These initial states may be stored in significantly reduced space compared to original weights (e.g., the original weights of the first weight matrix 310 of FIG. 3). In one or more implementations, these initial states and mathematical rule responsible for generating the original weights can be ascertained, enabling the storage of solely the states and thereby minimizing storage requirements.

In one or more implementations, seed-based projection includes projecting upon populated matrices from seeds and identifying the seeds that minimize the distance between a plausible weight and a projection error, facilitating efficient storage and approximate reconstruction of the original weights. In one or more implementations, the identified seeds may minimize a specific loss, such as a language modeling loss in large language models.

In one or more implementations, an algorithmic approach to identify these seeds may involve employing constrained optimization techniques. For example, for projection purposes, projected gradient-based methods may be utilized. In one or more implementations, the objective may be to minimize the original loss, and at each iteration (or every few iterations), the weights can be projected onto the most suitable space in terms of distance. This iterative process facilitates the discovery of optimal seeds for each training state. The process may be reiterated until a reasonable original loss is attained while remaining within the domain of the pseudo random generator 504.

In one or more implementations, projection loss may result in the broadcasting of projection error matrices, which may quantify the projection errors through a least squares approach, or alternative loss functions. This process may allow for the simultaneous evaluation of errors generated by different seeds and chunks in parallel. In one or more implementations, the seeds leading to the lowest error for each chunk may be selected. As illustrated in FIG. 7, region 710 includes chunks that may be produced by seeds (e.g., 730), while region 720 includes segments that may be smaller than the chunk size. In one or more other implementations, design variables may include chunk sizes (m), latent dimensions (t), chunking axes, LFSR bit-widths (or the number of bits allocated for determining the initial states), and rules for generating chunks from initial states. These variables can be optimized within this framework to minimize reconstruction error and enhance a custom objective.

FIG. 8 is a flow chart of an example process that may be performed for memory-efficient differentiable weight clustering for large language model compression in accordance with one or more implementations. For explanatory purposes, the process 800 is primarily described herein with reference to the electronic device 110 of FIG. 1. However, the process 800 is not limited to the electronic device 110 of FIG. 1, and one or more blocks (or operations) of the process 800 may be performed by one or more other components of other suitable devices and/or servers. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, an apparatus (e.g., the electronic device 110, 112, 114, 116) determines a first data structure that includes pseudo random values and a second data structure that includes one or more learned values based on a target compression ratio of a first dimension associated with a first weight matrix to a second dimension.

At block 804, the apparatus generates a second weight matrix that includes the second dimension with the second data structure and a seed value associated with the first data structure. In one or more implementations, the second weight matrix is generated based at least in part on the pseudo random values and the one or more learned values. In one or more implementations, the second weight matrix is a compressed version of the first weight matrix based on the target compression ratio.

At block 806, the apparatus produces a trained machine learning model by training a neural network with the second weight matrix.

FIG. 9 illustrates an electronic system 900 with which one or more implementations of the subject technology may be implemented. The electronic system 900 can be, and/or can be a part of, the electronic device 110, and/or the server 120 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding solid-state drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input device interface 914 and output device interface 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
determining a first data structure comprising pseudo random values and a second data structure comprising one or more learned values based on a target compression ratio of a first dimension associated with a first weight matrix to a second dimension;
generating a second weight matrix comprising the second dimension with the second data structure and a seed value associated with the first data structure, the second weight matrix being generated based at least in part on the pseudo random values and the one or more learned values, and the second weight matrix being a compressed version of the first weight matrix based on the target compression ratio; and
training a neural network with the second weight matrix to produce a trained machine learning model.

2. The method of claim 1, wherein the first dimension comprises at least a portion of a column in the first weight matrix and the second dimension comprises at least a portion of a column in the second weight matrix.

3. The method of claim 1, further comprising storing the seed value and the second data structure in memory.

4. The method of claim 1, wherein the determining the second data structure comprises determining the one or more learned values of the second data structure based on different instances of the first data structure associated with respective seed values.

5. The method of claim 1, further comprising determining a set of pairings between the first data structure and the second data structure that produces an approximation of at least a portion of the first weight matrix based on the target compression ratio by iterating between a plurality of sets of data structures comprising different instances of the first data structure.

6. The method of claim 1, further comprising determining an approximation of at least a portion of the first weight matrix based at least in part on the first data structure and the second data structure at an inference time during deployment of the trained machine learning model.

7. The method of claim 1, wherein the one or more learned values of the second data structure comprises non-zero values at sparse locations within the second data structure, wherein the non-zero values of the second data structure correspond to respective vectors of pseudo random values at sparse locations within the first data structure.

8. The method of claim 1, wherein the first data structure represents a circulant matrix with columns in the first data structure being rotations of one another based on a pseudo random vector.

9. The method of claim 1, further comprising adjusting the seed value during training of the neural network based on one or more states of a linear feedback shift register that indicate the seed value.

10. The method of claim 1, further comprising reconstructing one or more weights of the first weight matrix from one or more seed values that minimize a distance between a plausible weight and a projection error, wherein the second weight matrix includes the one or more seed values.

11. A device, comprising:
a memory; and
one or more processors configured to:
determine a first data structure comprising pseudo random values and a second data structure comprising one or more learned values based on a target compression ratio of a first dimension associated with a first weight matrix to a second dimension;
generate a second weight matrix comprising the second dimension with the second data structure and a seed value associated with the first data structure, the second weight matrix being generated based at least in part on the pseudo random values and the one or more learned values, and the second weight matrix being a compressed version of the first weight matrix based on the target compression ratio; and
train a neural network with the second weight matrix to produce a trained machine learning model.

12. The device of claim 11, further comprising:
a data tensor;
a pseudo random generator coupled to the data tensor and configured to generate the first data structure based at least in part on input values from the data tensor;
a kernel buffer configured to store the second data structure;
a multiplier coupled to the pseudo random generator and the kernel buffer, and is configured to perform a convolutional operation with the first data structure and the second data structure;
an adder coupled to the multiplier and configured to generate a weighted sum from the convolutional operation, wherein the weighted sum is configured to update at least a portion of the second data structure stored in the kernel buffer; and
an accumulator coupled to the adder and configured to generate an accumulation of weighted sums produced by the adder.

13. The device of claim 12, wherein the one or more processors are further configured to store the seed value and the second data structure in at least a portion of the kernel buffer.

14. The device of claim 11, wherein the one or more processors are further configured to produce a trained machine learning model by training a neural network with the second weight matrix.

15. The device of claim 11, wherein the one or more processors configured to determine the second data structure are further configured to determine the one or more learned values of the second data structure based on different instances of the first data structure associated with respective seed values.

16. The device of claim 11, wherein the one or more processors are further configured to determine a set of pairings between the first data structure and the second data structure that produces an approximation of at least a portion of the first weight matrix based on the target compression ratio by iterating between a plurality of sets of data structures comprising different instances of the first data structure.

17. The device of claim 11, wherein the one or more processors are further configured to determine an approximation of at least a portion of the first weight matrix based at least in part on the first data structure and the second data structure at an inference time during deployment of a trained machine learning model.

18. The device of claim 11, wherein the one or more learned values of the second data structure comprises non-zero values at sparse locations within the second data structure, wherein the non-zero values of the second data structure correspond to respective vectors of pseudo random values at sparse locations within the first data structure.

19. The device of claim 11, wherein the first data structure represents a circulant matrix with columns in the first data structure being rotations of one another based on a pseudo random vector.

20. A non-transitory machine-readable medium comprising code that, when executed by a processor, causes the processor to perform operations comprising:
determining a first data structure comprising pseudo random values and a second data structure comprising one or more learned values based on a target compression ratio of a first dimension associated with a first weight matrix to a second dimension;
generating a second weight matrix comprising the second dimension with the second data structure and a seed value associated with the first data structure, the second weight matrix being generated based at least in part on the pseudo random values and the one or more learned values, and the second weight matrix being a compressed version of the first weight matrix based on the target compression ratio; and
training a neural network with the second weight matrix to produce a trained machine learning model.
